(19) United States
(12) Patent Application Publication
(10) Pub. No.: US 2008/0148914 A1
(43) Pub. Date: Jun. 26, 2008

(54) Device For Longitudinal Cutting of a Continuous Web Material and Machine Comprising Said Device

(76) Inventor: Alessandro Micheli, Lucca (IT)

Correspondence Address: MCGLEW & TUTTLE, PC, P.O. BOX 9227, SCARBOROUGH STATION, SCARBOROUGH, NY, 10510-9227, US

(21) Appl. No.: 11/815,925

(22) PCT Filed: Feb. 28, 2005
(86) PCT No.: PCT/IT2005/000113

§ 371 Date: Aug. 9, 2007

(51) Int. Cl. B26D 1/56; B31B 1/00

(52) U.S. Cl. 83/286; 493/30

(57) ABSTRACT

The device comprises at least a first series of slides (21) each carrying a respective cutting tool (9). The slides are adjustable and clampable in pre-established positions along a beam (11) extending more or less transversely with respect to the direction of feed of the web material. Moreover, a system to clamp the slides along said beam and a translation member (71) to translate and position said slides along the beam are provided. The clamping system comprises, for each slide, a pressing member (33) elastically stressed against a fixed surface (29A) integral with the beam, while the translation member comprises an actuator (74) cooperating selectively with one or other of said pressing members, to release the pressing member from the fixed surface and draw the slide by means of the translation member and position it along said beam.

### TECHNICAL FIELD

The present invention relates to devices for longitudinal cutting of a web material, for example nonwoven fabric, paper, tissue paper or the like. More specifically, the present invention relates to a cutting device comprising a plurality of blades and a plurality of counter-blades positionable in variable arrangements along a direction transverse to the direction of feed of the web material, to divide the material into an optionally variable number of strips of a width settable and modifiable according to specific production requirements.

### PRIOR ART

In the production of rolls of web material, such as rolls of nonwoven fabric, tissue paper or the like, winding or rewinding machines are used, which are fed with a web material of considerable width coming from a parent reel or from a continuous production machine or line, such as a production line for a nonwoven fabric. This starting web material is divided longitudinally into a variable number of individual strips of a selectable width to form rolls of a predetermined axial extension. Consequently, several rolls of the same or even of a different width are produced simultaneously from each web material.

Machines of this type therefore have a station for unwinding or in line production of the web material and a winding unit and, between these two sections, an arrangement of cutting tools formed by a series of blades and a respective series of counter-blades rotating and positionable as a function of the width of the strips to be obtained from the initial web material.

As mentioned above, as the width of the strips can vary according to the production batch, and optionally in subsequent winding cycles variable numbers of rolls can be produced from the same initial web material, systems have been designed to rapidly position and clamp the cutting tools in the desired transverse positions.

For example, U.S. Pat. No. 4,188,846 describes a positioning system, in which slides supporting the blades or counter-blades are engaged alternatively with a clamping bar or with a single member provided with alternate movement. By connecting one or other of the tool-holding slides selectively to the moving member with alternate motion it is possible to translate the individual slides and carry them to the desired position, where they are then clamped by a piston cylinder actuator.

U.S. Pat. No. 4,420,996 describes an analogous cutting device with blades and counter-blades carried by respective slides and systems for manual clamping of the slides and consequently of the tools in the desired transverse positions. The release, translation and clamping operations are performed manually.

U.S. Pat. No. 4,592,259 describes a cutting device in which a double piston-cylinder actuator is used to clamp each slide in its position, that is, to connect each slide to a translation bar which moves the slides connected thereto in the direction transverse to the direction of feed of the web material to position the tools.

U.S. Pat. No. 4,934,234 describes a similar system for translation of the cutting tools (blades and counter-blades) in the transverse direction with respect to the feed direction of the web material. In this case each slide of the blades and each slide of the counter-blades is selectively connectable or releasable with respect to a nut screw meshing with a threaded bar. Two simultaneously controlled threaded bars are provided respectively for the two series of blades and counter-blades. A piston-cylinder system selectively clamps one or other of the slides with respect to the nut screw so that rotation of the bar engaged in the nut screw causes translation of said slides.

U.S. Pat. No. 5,125,301 describes a device in which the transverse movement of the blades takes place by selectively engaging the slides supporting the blades with a continuous flexible member, such as a belt driven around two pulleys. A piston-cylinder actuator on each slide also clamps the slide in the transverse position reached.

U.S. Pat. No. 4,092,886 describes a system to position blades and counter-blades transverse to the direction of feed of the web material with a manual positioning mechanism and a system to clamp and release each slide by means of a piston-cylinder actuator.

U.S. Pat. No. 4,607,552 describes a mechanism in which the blades and counter-blades are positioned by means of a motor which rotates a pinion meshing on a rack integral with the beam along which the slides are positioned transversely. An electric clutch between motor and pinion is alternatively used to transmit motion from the motor to the pinion, or else to clamp the respective slide in the set position.

U.S. Pat. No. 6,840,898 describes another system for positioning tools in the direction transverse to the direction of feed of a continuous web material, based on the selective engagement of the tool-supporting slides with a flexible member driven between two pulleys, analogously to the description in U.S. Pat. No. 5,125,301. Similar tool translation and positioning systems are described in U.S. Pat. No. 5,072,641 and U.S. Pat. No. 5,259,255.

DE-A-19904182 describes a device for positioning and clamping disk-shaped cutting tools in which the individual blades are carried by slides engageable by means of jaws carried by a translation member, which slides on guides integral with a beam transverse to the direction of feed of the web material to be cut. Guides for translation of the slides are provided on the same beam. The translation member selectively engages one or other of the tool-supporting slides and translates them to the desired position, where they are clamped by means of a brake carried by the slide and operated by a specific actuator.

U.S. Pat. No. 4,649,782 describes a longitudinal cutting unit of the web material with a series of blades and a series of counter-blades carried by respective slides sliding on beams transverse to the direction of feed of the web material. Movement and positioning of the slides take place by means of individual motors carried by the blade slides, while the counter-blade slides are drawn by the blade slides thanks to a reciprocal engaging mechanism. A piston-cylinder actuator clamps the slides in the selected positions.

U.S. Pat. No. 4,380,945 describes a further blade and counter-blade positioning system for a rewinding machine, in which clamping, release and translation of the individual tools are performed manually.

U.S. Pat. No. 3,176,566 describes a positioning and clamping mechanism analogous to the one described in U.S. Pat. No. 4,607,552, with slides supporting the blades and counter-blades moved by electric motors with interposing of an electric clutch which provides transmission between a pinion and the motor, the pinion meshing in a rack integral with the beam carrying the slides. The electric clutch is also used to clamp the individual slide in the desired position.

U.S. Pat. No. 4,422,588 describes a rewinding machine which engages a cutting unit with blades and counter-blades positionable selectively in the direction transverse to the direction of feed of the web material.

U.S. Pat. No. 5,735,184 describes cutting device with blades and counter-blades carried by respective slides selectively positionable along supporting beams. A translation member is selectively engageable with one or other of the tools to translate said tools to the desired position. Once all the tools have been positioned they are clamped by a common clamping system, composed of an expandable axis on which the tools are supported.

EP-A-1,245,354 describes a further cutting tool positioning device for a longitudinal cuffing device in a rewinding machine. In this case the tools are individually positioned by means of a translation member running parallel to the supporting beam of the guides on which the tool-supporting slides slide. A jaw carried by the translation member engages one or other of the tool-supporting slides when they are released in advance by the beam. After having positioned the tools by means of the translation member, the slides are simultaneously clamped on the beam by means of a common pneumatic device.

In cutting units in which a single clamping system simultaneously clamps all the blades or counter-blades in the position in which they have been carried by the positioning device, each time even only one tool must be moved, for example to modify the width of the rolls being produced, all the tools must be taken to the inoperative position and then released. Subsequently, the tools to be moved are repositioned, all the tools are once again clamped in their respective positions and returned to the operating arrangement. If feed of the web material cannot be interrupted, for example due to the fact that it is produced in line by a continuous machine, the material is wound continuously also during the positioning or re-positioning phase of the tools or some of the tools and the reel formed during the positioning phase of the blades must be totally discarded.

On the other hand, devices with individual clamping means are particularly complex and cumbersome and consequently influence the production cost, maintenance and also the versatility of said devices, as the overall dimensions of the devices associated with each cutting tool poses limits to the minimum width of each strip of web material that can be produced by the cut.

### OBJECTS AND SUMMARY OF THE INVENTION

The object of the present invention is to produce a device for longitudinal cutting of a continuous web material, of the type comprising: a series of adjustable tool-supporting slides, a slide clamping system and a translation member to translate and position the slides, which is more efficient, has a simpler construction and is more reliable than conventional devices.

The object of an improved embodiment of the invention is to produce a device of this type which allows easy positioning of the individual tools also during operation of the winding or rewinding machine to which the device is fitted, that is, without interrupting the feed of the web material.

In substance, according to a first aspect, the invention provides a device for longitudinal cutting of a continuous web material, comprising: at least a first series of slides each carrying a respective cutting tool, said slides being adjustable and clampable in defined positions along a first beam extending transversely with respect to the direction of feed of the web material; a system for clamping the slides along said beam; a translation member to translate and position said slides along the beam. The clamping system comprises, for each slide, a respective pressing member stressed elastically against a fixed surface integral with the beam; moreover, the translation member comprises an actuator cooperating selectively with one or other or said pressing members, to release the pressing member from the fixed surface, against the effect of an elastic member which stresses it against said surface, and to draw the slide by means of the translation member and position it along said beam.

In practice, each slide is clamped in position by means of a passive member, rather than using an actuator, as provided in some conventional systems. This makes construction and control of the cutting system much simpler. Moreover, the individual cutting tools are more compact and have smaller dimensions, thus allowing greater versatility in terms of transverse dimensions obtainable by cutting of the web material.

With the device according to the invention it is also easier to position a single tool or single pair of tools by releasing it from the supporting beam, while the other tools continue to operate. In this way, for example, when the position of a limited number of tools requires to be changed and the web material cannot be halted, the waste produced is reduced to only the rolls produced by the tools the position of which is to be modified, while the tools remaining in the same position can continue to operate producing useful rolls.

Using separate motors for the cutting tools or a splined bar in which all the cutting tools can slide, it is possible to keep rotating the tools and simultaneously translate them for positioning.

According to a possible embodiment of the invention, each slide is slidingly engaged with at least one guide integral with the beam and extending parallel thereto. The guide provides a reaction force against the thrust of the actuator and of the pressing member on the respective slide. Preferably, to obtain a more efficient structure, integral with the beam are two parallel guides, along which said tool-holding slides are slidingly engaged. The two guides provide reaction forces against the thrust of the actuator and of said pressing member on the respective slide.

Preferably, the pressing member of each slide is disposed between the two guides, with which a particularly advantageous constructional geometry is obtained from the point of view of strains and stresses. The fixed surface integral with the beam against which the pressing members press to clamp the tool-holding slides is preferably disposed between the two guides, and the actuator of the translation member acts on the pressing members in the intermediate area between the two guides. Preferably, the fixed surface is divided into two portions parallel to a longitudinal opening produced in the beam, through which the actuator of the transfer member acts on one or other of the pressing members associated with the tool-supporting slides.

According to an advantageous embodiment of the invention, each pressing member has a rod extending parallel to the direction of movement to engage and disengage the pressing member with respect to the fixed surface, which is associated with a member to lift the pressing member manually from said fixed surface.

When the device has blades and counter-blades, or in general two series of tools wherein each tool of one series cooperates with a tool of the other, an analogous arrangement of members can be provided for the second series of tools.

The invention also relates to a machine for processing a web material, for example, although not exclusively, a winding or rewinding machine, characterized in that a device as defined above is provided along the path of the web material.

Further advantageous characteristics and embodiments of the invention are indicated in the appended claims.

### BRIEF DESCRIPTION OF THE DRAWINGS

The invention shall now be better understood by following the description and accompanying drawings, which show a non-limiting practical embodiment of the invention. More specifically, in the drawing:

FIG. 1 shows a diagram of a rewinding machine comprising a device according to the invention;

FIG. 2 shows a cross section of a first beam carrying the slides with the cutting blades;

FIG. 3 shows a view according to III-III in FIG. 2;

FIG. 4 shows a cross section of the second beam carrying the slides with the counter-blades;

FIG. 5 shows a view according to V-V in FIG. 4.

### DETAILED DESCRIPTION OF AN EMBODIMENT OF THE INVENTION

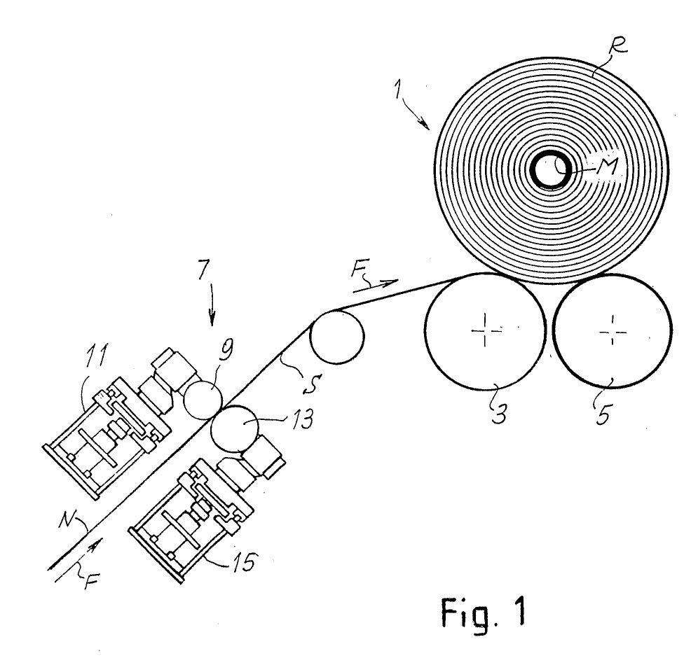

FIG. 1 schematically shows a winding or rewinding machine 1, comprising a pair of lower winding rollers 3 and 5 forming a cradle on which the rolls of web material N are formed, which is fed to the rewinding machine passing through a cutting unit indicated as a whole with 7. By means of a series of blades and counter-blades, this cutting unit divides the web material N into a plurality of strips S parallel to one another. These strips, of variable length settable by the user, are wound to form around a common spindle M a series of axially aligned rolls R.

The cutting unit 7 comprises a first series of cutting tools, composed of blades 9 carried by a beam 11 extending transversely with respect to the direction of feed F of the web material N. The blades 9 cooperate with counter-blades 13 forming a second series of tools and carried by a second beam 15. The blades and counter-blades 9 and 13 are disposed on opposite sides of the feed path of the web material and can be positioned as desired along the transverse extension of the web material N to divide it into a variable number of strips S with dimensions settable by the user.

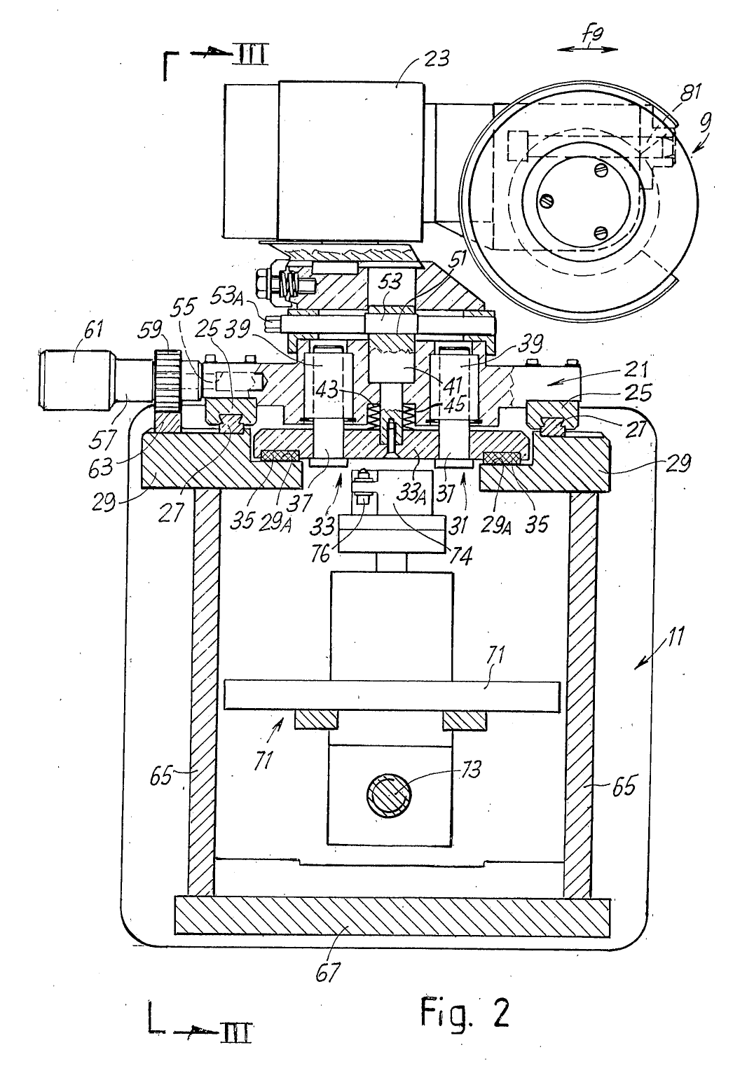

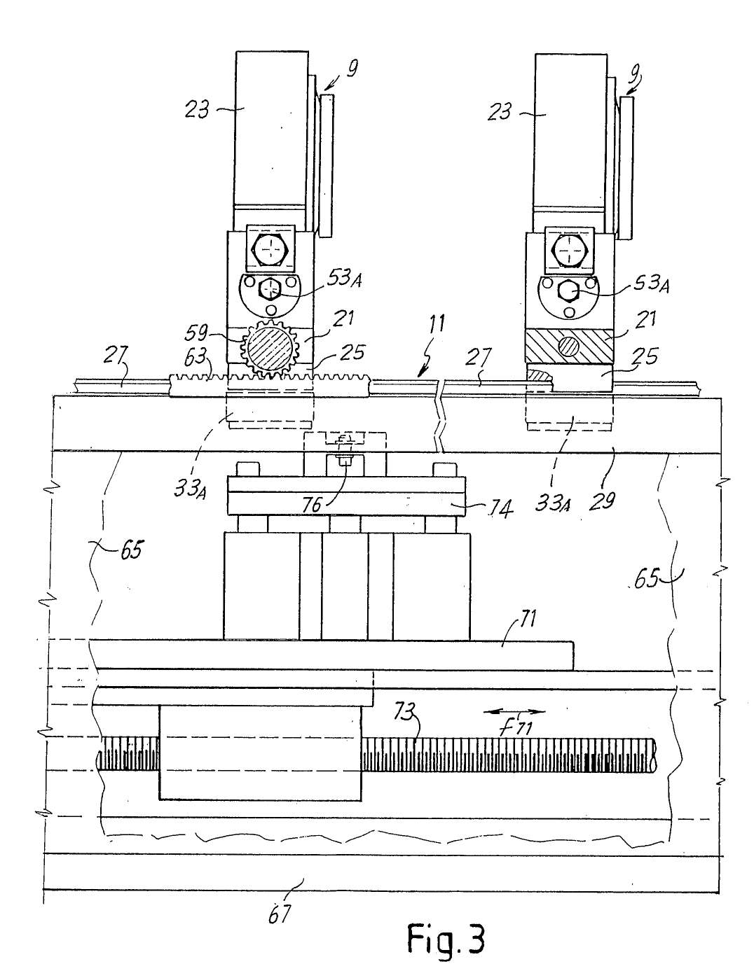

FIGS. 2 and 3 respectively show a cross section of the beam 11 with one of the blades 9 and a back view according to II-II of a portion of said beam 11 with two tools. It will be understood that, in actual fact, blades 9 are disposed on this beam 11 in a variable number suitable for the requirements of the specific machine on which the cutting unit 7 is mounted.

With reference to FIGS. 2 and 3, each cutting blade 9 is carried by a slide 21 sliding and positionable along the beam 11. The blade 9 has a disk-shaped cutter mounted idle on an axis thereof and provided with an advancing movement towards the respective counter-blade. The advancing movement is double, as the blade can move according to the arrow f9 (FIG. 2) orthogonally to the longitudinal extension of the beam 11 and also parallel to the extension of said beam 11. The actuators which perform this double movement are contained in the housing 23 which is part of the cutting tool. The unit 9, 23 is available on the market and known per se, and therefore no further descriptions of the detailed characteristics thereof are required herein.

Each slide 21 is engaged by means of shoes 25 to two guides 27 parallel to each other and to the longitudinal extension of the beam 11. The guides 27 are fixed on two section bars 29 which are integral with the beam 11 and between which a longitudinal opening 31 is defined for the purposes described hereunder.

Each slide 21 is provided with a pressing member 33 which extends transversely with respect to the opening 31 of the beam 11, defined by the section bars 29. The pressing member 33 is provided with two pads or blocks 35 made of rubber, plastic or another material with a high friction coefficient, which are carried into contact with and pressed against two flat surface portions 29A provided on the section bars 29 and disposed at the sides of the slot or longitudinal opening 31.

The pressing member 33 is essentially composed of a plate 33A, integral with which are two guide bars 37 sliding in recirculating ball bushings 39 connected to the slide 21. In an intermediate position between the two guide bars 37 the plate 33A of the pressing member 33 is equipped with a rod 41 orthogonal to the plate 33A and disposed around which is a pack of Belleville springs 43, which react between the upper surface of the plate 33A and the base of a seat 45 produced in the slide 21. The Belleville springs 43 therefore press the pressing member with its blocks 35 against the fixed surface integral with the beam 11, formed by the two surface portions 29A.

The upper part of the rod 41 is provided with a transverse hole 51 inside which an eccentric pin is inserted, one end 53A of which projects from its seat, produced in the slide 21, to allow the pin 53 to be rotated by means of a specific key. Rotation of the pin 53 causes lifting of the pressing member 33 against the action of the Belleville springs 43, which are compressed when the eccentric pin 53 lifts the rod 41 integral with the plate 33A of the pressing member 33.

The end of a pin 57 can engage in a hole 55 of the slide 21, onto which pin a pinion 59 is keyed, and which is provided with a grip 61. The pinion 59 meshes with a rack 63 integral with the beam 11 and extending parallel to the guides 27. This arrangement allows the slide 21 with its respective tool 9 to be moved manually along the longitudinal extension of the beam 11 when this is necessary. For this purpose, it is sufficient to rotate the eccentric pin 53 to lift the pressing member 33, consequently releasing the slide 21, which is normally clamped in position on the beam 11 through the effect of the pressure of the blocks 35 integral with the pressing member 33 against the fixed surface integral with the beam 11 composed of the two portions of surface 29A. Once it has been released with respect to the beam 11, the slide 21 can be translated precisely by manually rotating the pinion 59.

The section bars 29 form, together with plates 65, 67, a box structure which receives a translation member 71, movable by means of a recirculating ball threaded bar 73 along the beam 11 inside the box structure 65, 67 and 29.

The translation member 71 comprises a carriage or slide sliding along guides inside the box beam and is provided with a piston-cylinder actuator 74 orthogonal to the longitudinal extension of the beam 11. The lifting and lowering movement according to the arrow f74 of the piston-cylinder actuator 74 allows each slide 21 to be selectively engaged lifting the respective pressing member 33 against the action of the spring 43 to thus detach the blocks 35 from the fixed surface formed by the portions 29A. With this mechanism it is possible to release, position and clamp again each of the slides 21 with the respective tool 9 in the desired position. In fact, the member 71 can translate according to f71 (FIG. 3) along the entire longitudinal extension of the beam 11 to position itself with its actuator 74 selectively under each slide 21 the tool 9 of which must be repositioned.

Once carried under the slide 21 the actuator is lifted to compress the Belleville springs 43 lifting the pressing member 33 from the surfaces 29A and consequently releasing the slide with respect to the beam 11. By translating at this point the member 71 by rotating the threaded bar 73 it draws the slide 21 and the respective tool with it to the new position. Here the actuator 74 is lowered to allow the Belleville springs 43 to press the pressing member 33 with the blocks 35 against the fixed surface 29A, consequently clamping the slide in the new position.

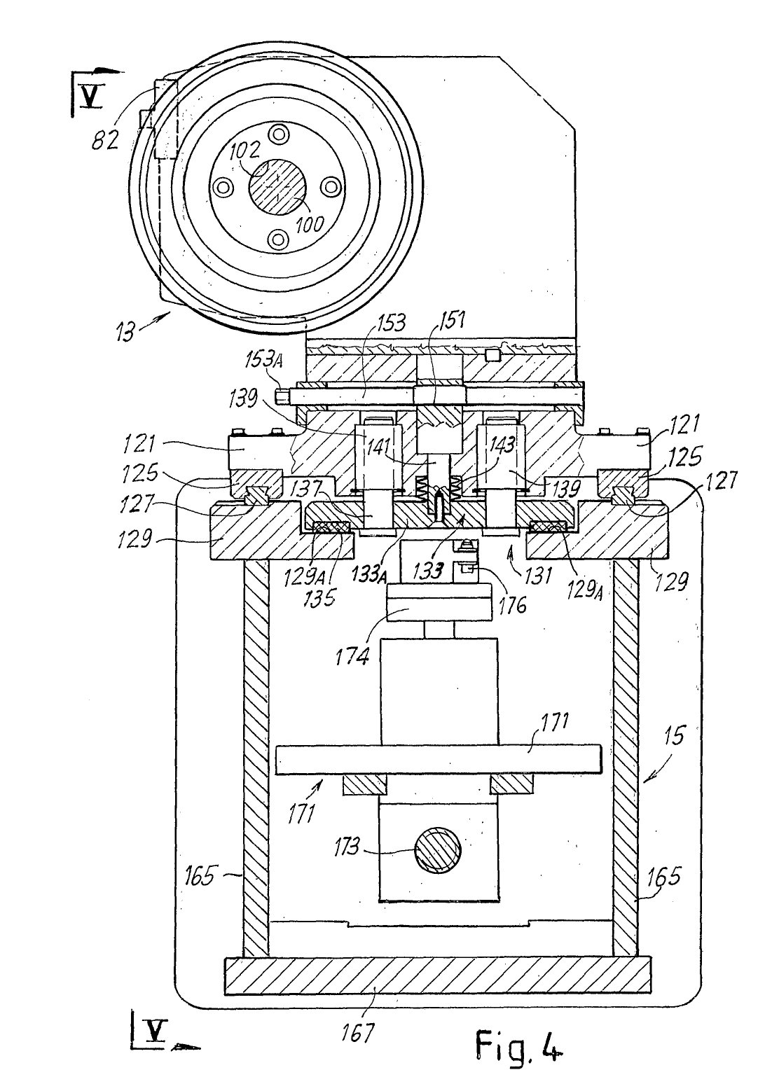

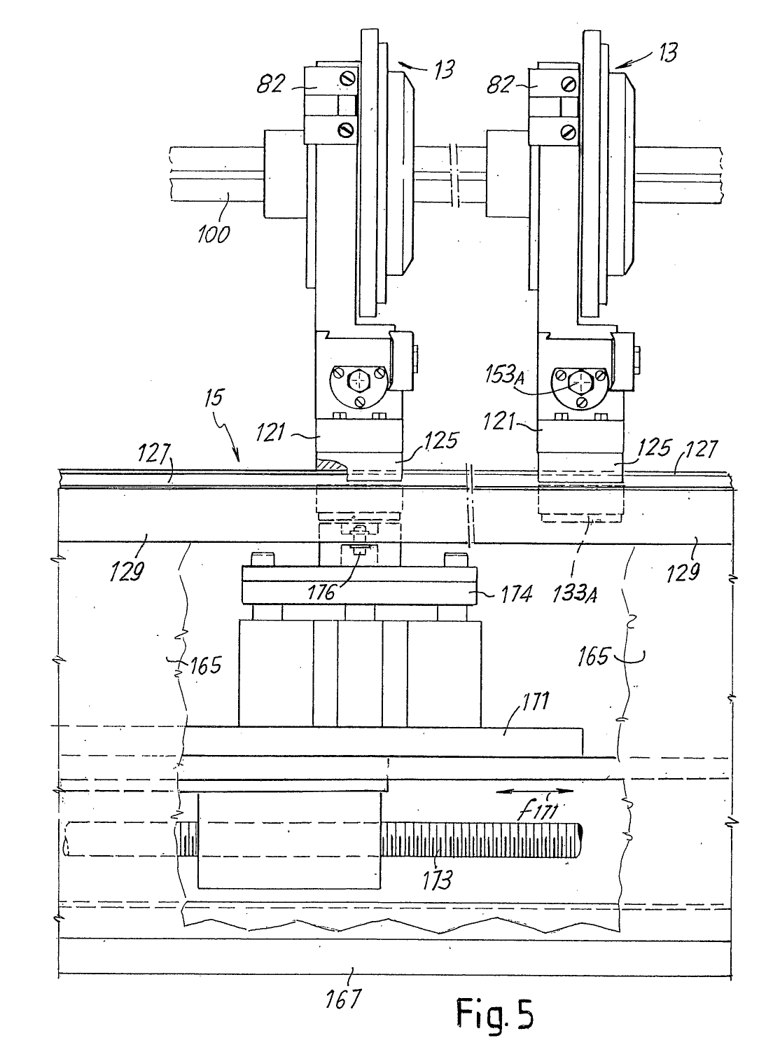

FIGS. 4 and 5 show an analogous arrangement for movement of the slides carrying the counter-blades 13. As the structure of the slides and of the beam 15 which carries them are essentially identical to the beam 11 and slide 21, identical or corresponding parts are indicated with the same reference numbers increased by 100. Therefore, the slide supporting the tools 13 is indicated with 121, the shoes with 125 and the guides with 127. The structure of the beam 15 is formed by two section bars 129 each forming a flat surface 129A, the two flat surfaces 129A forming as a whole the fixed surface against which the blocks 135 of the pressing member 133 act, the plate or main body of which is indicated with 133A.

The pressing member 133 of each slide 121 supporting the respective tools or counter-blades 13 extends transversely with respect to a longitudinal opening 131 of the beam 15. The number 141 indicates the rod, disposed around which is the pack of Belleville springs 143 housed in the seat 145 which stresses the pressing member 133 against the fixed surface composed of the portions of surface 129A. The rod 141 is again provided with a transverse hole 151 for an eccentric pin 153, the outer end 153A of which allows connection by a tool to rotate said pin and consequently lift the plate 133A of the pressing member 133 to release the slide 121 from the beam 15, leaving it free to translate along the guides 127.

The numbers 137 and 139 indicate the guide bars and the recirculating ball bushings which, analogously to the corresponding elements 37 and 39 for the slide 21, guide the movement of the pressing member 133.

The beam 15 has a box structure analogous to the structure of the beam 11 and, in addition to the section bars 129, is composed of the lateral section bars 165 and of the base plate 167. Extending inside the box structure thus composed is the threaded bar 173 which controls movement of the translation member 171 which, analogous to the member 71, carries a piston-cylinder actuator 174, equivalent to the actuator 74, which is used to engage the individual slides 121, releasing them from the beam 15 to translate and position them.

The slides 121 are devoid of the seat to engage a pin analogous to the pin 57 and consequently the beam 15 has no rack equivalent to the rack 63. In fact, manual translation of the individual slide 121 along the beam 15 takes place by means of the pin 57, the pinion 59 and the rack 53 associated with the tool unit 9, temporarily connecting the tool 9 to be translated to the corresponding tool 13. This is obtained by means of a pin 81 (FIG. 2) integral with the tool 9 and engageable in a corresponding seat 82 integral with the respective corresponding tool 13. When a specific tool 9 must be translated manually along the beam by means of the pin 57, the pinion 59 and the rack 73, the operator will clamp the tool 9 to the corresponding tool 13 by means of the rod or pin 81 which is inserted into the seat 82, so that rotation of the pinion 59 will cause translation along the beams 11 and 15 of both the tools thus connected to each other.

The tools or counter-blades 13 are motorized, contrary to the blades 9 which are mounted idle on their respective supports. In the example shown all the tools or counter-blades 13 are carried in rotation by a common motorized bar 100, which extends parallel to the beam 15 through a hole 102 of each counter-blade 13. A splined profile coupling allows the tools 13 to slide along the bar 100 and at the same time transmission of rotational motion.

Alternatively, each counter-blade 13 can be equipped with its own motor, as illustrated, for example, in EP-A-1245519.

In brief, the device operates as follows. In a specific operating condition the various tools 9 and 13 are positioned in specific positions along the transverse extension of the web material N, and each tool is clamped in position through the effect of the Belleville springs 43 and 143, which push the pressing members 33 and 133 against the fixed surfaces 29A and 129A respectively.

When it is necessary to place a pair of tools 9, 13 in a different position, the respective translation members 71 and 171 are positioned so as to carry the respective actuators 74 and 174 to the level of the pressing members 33 and 133 of the pair of slides 21 and 121 carrying the tools 9 and 13 that must be repositioned. The actuators 74 and 174 extend engaging the pressing members 33 and 133 and lifting them against the antagonistic force of the Belleville springs 43 and 143 and consequently releasing the slide 21 or 121 from the beam 11 or 15. After release, the translation members 71 and 171 are moved by means of the threaded screws 73 and 173, drawing the slides 21 and 121 with them to the new position in which the cutting tools 9 and 13 must be disposed. Before starting to translate, the aforesaid tools have been moved away from one another, for example by means of a double movement of the blade 9 with respect to the counter-blade 13, the latter remaining in the same position with respect to the slide 121 that carries it.

After reaching the new transverse position along the extension of the beam 11 and 15, the two actuators 74 and 174 are retracted to allow the Belleville springs 43 and 143 to re-expand and press the pressing members 33 and 133 with their blocks 35 and 135 against the fixed surfaces 29A and 129A to clamp the tools 9 and 13 in the new position.

Encoders, not shown, associated with the threaded bars 73 and 173 or directly with the translation members 71 and 171, continuously control the position of these members, so that the control unit, with which the device is equipped, at all times knows the true position of the slides 21 and 121 and consequently of the respective tools 9, 13. The central control unit can therefore perform positioning of the tools in any of a plurality of positions, which may be pre-stored, according to the processing orders.

To guarantee greater precision during movements, the actuators 74 and 174 can be equipped with rods or pins that are inserted in corresponding seats provided in the lower surface of the pressing members 33 and 133. Moreover, to further guarantee correct operation of the device, microswitches indicated with 76 and 176 can be associated with the actuators 74 and 174, which are capable of checking that the respective actuator has engaged with the pressing member 33 or 133.

It is understood that the drawing purely shows an example provided only as a practical embodiment of the invention, which may vary in forms and arrangements without however departing from the scope of protection on which said invention is based. Any reference numerals in the appended claims are provided for the sole purpose of facilitating reading in the light of the description and the drawing, and do not in any manner limit the scope of protection represented by the claims.

1. A device for longitudinal cutting of a continuous web material, comprising:
at least a first series of slides each carrying a respective cutting tool, said slides being adjustable and clampable in pre-established positions along a first beam extending substantially transversely with respect to the direction of feed of the web material;
a clamping system of the slides along said beam;
a translation member to translate and position said slides along the beam; wherein said clamping system comprises, for each slide, a respective pressing member stressed elastically against a fixed surface integral with the beam; and wherein said translation member comprises an actuator cooperating selectively with one or other of said pressing members, to release the pressing member from the fixed surface against the effect of an elastic member which stresses said pressing member against said surface, said actuator drawing the slide by means of the translation member and positioning it along said beam.

2. Device as claimed in claim 1, wherein said translation member comprises a carriage moving inside a box structure forming part of said beam.

3. Device as claimed in claim 1, wherein each of said slides is slidingly engaged with at least one guide integral with said beam, said at least one guide providing a reaction force against the thrust of said actuator and of said pressing member on the respective slide.

4. Device as claimed in claim 1, wherein integral with said beam are two parallel guides, along which said slides are slidingly engaged, said guides providing reaction forces against the thrust of said actuator and of said pressing member on the respective slide.

5. Device as claimed in claim 4, wherein the pressing member of each slide is disposed between said two guides.

6. Device as claimed in claim 5, wherein said fixed surface integral with the beam is disposed between said two guides.

7. Device as claimed in claims 6, wherein said box structure has a longitudinal opening disposed between said two guides, through which said actuator acts, the pressing members of the slides extending in front of said longitudinal opening.

8. Device as claimed in claim 7, wherein said fixed surface integral with the beam is defined by two edges extending along said longitudinal opening.

9. Device as claimed in claim 1, wherein each pressing member is connected to the respective slide by means of guide bars sliding in respective bushings.

10. Device as claimed in claim 1, wherein each pressing member is stressed against the fixed surface integral with said beam by means of a plurality of Belleville springs or another elastic member.

11. Device as claimed in claim 1, wherein each of said pressing members comprises a member for manual lifting of the pressing member from the fixed surface.

12. Device as claimed in claim 1, wherein each of said pressing members has a rod extending parallel to the direction of movement to engage and disengage the pressing member with respect to said fixed surface, which rod is associated with a member for manual lifting of the pressing member from said fixed surface.

13. Device as claimed in claim 12, wherein said manual lifting member comprises an eccentric pin operatable manually and engaged in a transverse hole of said rod.

14. Device as claimed in claim 1, further comprising a device for manual translation of said slide along said beam.

15. Device as claimed in claim 14, wherein said device for manual translation comprises a rack integral with said beam and at least one pinion, engageable with said slides, meshing with said rack, rotation of the pinion engaged with a slide causing translation of the slide along the beam.

16. Device as claimed in claim 1, wherein said pressing members have blocks in a material with a high friction coefficient, acting on the fixed surface integral with the beam.

17. Device as claimed in claim 1, wherein said actuator is a piston-cylinder actuator.

18. Device as claimed in claim 1, further comprising:
a second series of slides, each carrying a cutting tool cooperating with a corresponding tool carried by a slide of the first series of slides, wherein the slides of the second series are adjustable and clampable in pre-established positions along a second beam, parallel to said first beam, the web material being fed along a path between said first and said second beam, wherein the slides of said second series each have a clamping member comprising a pressing member elastically stressed against a fixed surface integral with the second beam to individually clamp each slide along said beam;
a second translation member with an actuator cooperating selectively with one or other of the pressing members of the slides of the second series being provided to selectively release said pressing members from the fixed surface integral with the second beam and draw the respective slide along said beam.

19. Device as claimed in claim 18, wherein the slides of said second series and said second beam are designed substantially similar to the slides of the first series and the first beam, respectively.

20. Device as claimed in claim 18, wherein each slide of the first series comprises a member for temporary connection to a corresponding slide of the second series.

21. A machine for processing a web material, wherein provided along the path of said web material is a device as for longitudinal cutting of a continuous web material, said device comprising:
at least a first series of slides each carrying a respective cutting tool, said slides being adjustable and clampable in pre-established positions along a first beam extending substantially transversely with respect to the direction of feed of the web material;
a clamping system of the slides along said beam;
a translation member to translate and position said slides along the beam; and
wherein said clamping system comprises, for each slide, a respective pressing member stressed elastically against a fixed surface integral with the beam; and wherein said translation member comprises an actuator cooperating selectively with one or other of said pressing members, to release the pressing member from the fixed surface against the effect of an elastic member which stresses said pressing member against said surface, said actuator drawing the slide by means of the translation member and positioning it along said beam.

22. Machine as claimed in claim 21, wherein said machine is a winding machine or a rewinding machine, comprising a unit to wind strips formed by cutting said web material.

23. Device as claimed in claim 2, wherein each of said slides is slidingly engaged with at least one guide integral with said beam, said at least one guide providing a reaction force against the thrust of said actuator and of said pressing member on the respective slide.

24. Device as claimed in claim 2, wherein integral with said beam are two parallel guides, along which said slides are slidingly engaged, said guides providing reaction forces against the thrust of said actuator and of said pressing member on the respective slide.

25. Device as claimed in claim 24, wherein the pressing member of each slide is disposed between said two guides.
